(19) United States
(12) Patent Application Publication
(10) Pub. No.: US 2010/0311024 A1
(43) Pub. Date: Dec. 9, 2010

(54) Suspended exercise apparatus and method of use

(76) Inventor: William Schenck, Canton, GA (US)

Correspondence Address: WILLIAM SCHINCK, 208 WILLOW VIEW COURT, CANTON, GA, 30114, US

(21) Appl. No.: 12/799,713

(22) Filed: Apr. 30, 2010

Related U.S. Application Data
(60) Provisional application No. 61/214,827, filed on Apr. 30, 2009.

(51) Int. Cl. G09B 19/00

(52) U.S. Cl. 434/258

(57) ABSTRACT

Invention uses fitness, balance, and coordination improvement methods using a adjustable swing arm(s) and swivel which will suspend attached activity specific tethers and targets. Said invention's horizontal arms can be manipulated easily and set securely. The most basic setup enables one participant to successfully hit a target more than once because target always returns to its starting point.

The preferred embodiment of the original invention with its utility improvements provides multiple targets to be suspended and manipulated by one or more individuals with targets and or tossed objects returning to their starting points. This multiple suspended tether system adds on to the previous established research showing that using just the dominant hand to successfully hit a target improved coordination and balance of participants.

Inspiration for the Invention Utility Improvements

The original invention filled the need for those individuals that are bedridden to exercise in bed. The utility improvements add to these exercises the ability to improve their mind, eye, hand and foot coordination while supine, seated, assisted, or standing and by one individually or with more than one person.

The present invention was first described in a notarized Official Record of Invention on provisional patent No. 61,214,827 on Apr. 30, 2009. The utility improvements and design changes enable user of improved apparatus be able to perform almost any mind, eye, hand, and foot coordination exercises or activities in the supine, seated, semi-supported or standing position. There are no previously filed, nor currently any co-pending applications, anywhere in the world covering original invention or its utility design improvements. Utility design improvements simplify the device and make the make it more practical while enabling a larger variety of individuals to benefit from its use.

### FIELD OF THE INVENTION

The present invention includes all of the previously mentioned bed exercises from original patent. The utility improvements relate generally to a less complex apparatus and, more particularly, to said apparatus which provides activities and exercises to improve the mind-eye-hand-and foot coordination of the bedridden and those with limited or reduced physical abilities. The invention allows dynamic improvements from any individual's original skill level in a simple and safe manner. There has been extensive research in the field of vision therapy especially concerning the head and eye movement exercises included in the Cooksey and Cawthorne exercises. This research shows both physical agility and balance improvement from repetitively performing these eye and head movements.

### DETAILED DESCRIPTION OF THE INVENTION

The updated invention utilizes a fixed and secure vertical pole (C), one or more height-adjustable horizontal arms (B) which has an adjustable tether connector (E) to suspend a variety of attachments such as a soft foam ball (I), using any type of fixed length tether (F) or cord attachment system known in the field (see FIG. 1). Each of the horizontal arms (B) is connected to the vertical pole (C) by a height-adjustable bracket (A) that incorporates a friction lever (K) to lock the bracket (A) at the desired height and position (see FIG. 2). Using this type of attachment allows the horizontal arm to swivel 180 degrees (see FIG. 3). The adjustable bracket (A) can be fixed (set) at several positions around the individual to accommodate his level of ability for the appropriate exercise. The horizontal arms (B) can be removed or rotated out of the way when not in use and stored easily against the wall when the wall attachment (J) is used. Tethers (F) or any type cord (used in the field) would be attached to the appropriate object or ball (I) or using standard connecting devices already existing in the field.

The apparatus's horizontal arms (B) extend the object into a set position that can be easily manipulated by the individual (see FIG. 3/7). The individual can be supine, seated, standing with cane, or unassisted. The invention suspends the tether (F) and activity specific object (such as ball (I) off of the horizontal arm (B) so that the manipulated object always returns to its starting point. This device allows a person of limited physical mobility to repeatedly perform exercises without having to chase a dropped object or ball (I) during the activity. A break-away safety link (G) is incorporated to attach the tether (F) to the adjustable tether connector (E) (see FIG. 4/7). This will serve to reduce the danger of injury by entanglement with the tether (F) to the individual using the device.

This invention allows the individual to also successfully hit the ball (I) with their non-dominant hand and or feet along with any combination of the hands and feet. Being able to successfully combine manipulating the ball (I) with both hands and feet can increase ones agility, mind-eye-hand-to feet coordination in whole or in parts. The invention can be used by one or more participants in individual settings or in a group environment. An individual will be able to kick an object while at the same time hitting another target in any plane of motion. The invention allows participant to improve their overall physical health and specific coordination by enabling them to start at their most basic skill level and successfully advance through more challenging exercises at their own pace.

### BACKGROUND OF THE INVENTION

The invention allows for almost any mind-eye-hand-to foot coordination activity to be performed through the use of light-activity specific tethers attached to the adjustable horizontal arms (B) of the apparatus. Well established and researched vertigo prevention and balance improvement exercises including, but not limited to, the field of Vision Therapy can be performed on this new invention. There is also long-standing research including but not limited to the, “Cawthorne and Cookskey” head exercises, which documents that virtually all patients moving in this manner will note improved balance and coordination over time. Present invention's adjustable arms and tethers enables individual to duplicates these same head, eye and hand movements by providing attached tethers, targets and/or ball (I) (any object in field).

### ADVANTAGES OVER PREVIOUS PROVISIONAL PATENT

The advantages of present invention and added applications in utility patent will become clear with reference to the following more detailed descriptions and claims taken in conjunction with the accompanying updated/added drawings, in which the particular activities can be performed along with the function of each piece.

Attaching Activity Specific Tubes with Tethers:

Bands and cords are configured and designed out of any flexible material known in the art, including but not limited to, foam, elastic, rubber or plastic and would attach easily to above horizontal arms by sliding in such a way to enable participant to successfully manipulate therapy ball or balls on the other end of the tether. Horizontal arms (B) are inserted into the adjustable bracket (A) and locked into place with a spring-loaded button which snaps into a hole in the adjustable bracket (A) (see FIG. 2/7).

### Attaching Activity Specific Therapy Balls:

Therapy balls are designed to be easily manipulated by participant. They may be comprised of any soft material known in the art, including but not limited to, plastic, foam, or rubber. They are connected to the horizontal arm (B) by a tether or any connection devise known in the art, including but not limited to, a plastic snap hook, metal snap hook, or plug receptor for activity specific tether or cord.

### CROSS REFERENCES TO RELATED APPLICATION

USPTO Application #:20080026922

USPTO 3825262 Hand-held amusement devise with tethered ball and plural targets

USPTO US Patent 5176602(tethered kinesthetic exercises):

U.S. Pat. No.: 4,257,589 Abdominal Exercise Devise (uses suspended bowling ball for strength gain):

USPC Class: 473524.Patent Title: Devise to promote physical fitness, mental agility, adroitness and dexterity.

Patent Title: USPC Class 482 34 Balance Training and exercise Devise and Method. (Suspended Platform)

USPTO U.S. Pat. No. 5,580,249: 5,580,249: Apparatus for simulating mobility of a human

USPTO U.S. Pat. No. 6,098,458: Assessing movement and agility skills w/o a confining field

USPTO U.S. Pat. No. 5,657,996: Method and apparatus for teaching and improving manual dexterity and hand/eye coordination

U.S. Pat. No.: 3,806 121 Sportsman Muscular Developer Game Apparatus

U.S. Pat. No.: 5,338,027 Tossing and Catching Play Object-extension similar to animal legs (e.g., frog legs)

U.S. Pat. No.: 4,088,316 Depressurized tethered tennis ball training devise

U.S. Pat. No.: 6,890,288 Method and apparatus to exercise developmentally delayed, physically or neuro-logically impaired persons

U.S. Pat. No.: 4,138,107 Sports tethered ball practice devise

U.S. Pat. No.: 4,191,372 tennis trainer device

U.S. Pat. No.: 4,521,016 Ball game apparatus

U.S. Pat. No.: 5,255,911 Tethered ball pitching apparatus and method

U.S. Pat. No.: 6,705 960 Tetherball-Type game apparatus

U.S. Pat. No.: 6,704,012 Practice device for enhancing strike ability of a boxer

U.S. Pat. No.: Design Patent US D438,582

U.S. Pat. No.: 7,186,193 Exercise training apparatus for tennis players

U.S. Pat. No.: 7,297,079 Game System

### Supine/In Bed Apparatuses/Applications:

U.S. Pat. No.: 6,270,445 B1 In Bed exercise machine and method of use

U.S. Pat. No.: 6,241,642 B1 Bed exercise machine

U.S. Pat. No.: 4,165,335 Motorized exercise apparatus for mounting on hospital bed rail

U.S. Pat. No.: 4,925,184 Bed mountable exercise devise

U.S. Pat. No.: 4,882,032 exercise machine

U.S. Pat. No.: 4,993,407 Exerciser for disabled and/or aged people's arms and legs

U.S. Pat. No.: 5,005,829 Exercise machine for patients confined to bed

U.S. Pat. No.: 5,743,050 training room also serving as bedroom

U.S. Pat. No.: 5,820,519 Bed exercise machine

U.S. Pat. No.: 6,152,855 In-bed exercise machine and method of use

U.S. Pat. No. 4,515,364 to Rotella discloses an exercise device in the form of a rectangular body having openings for alternately receiving weights or for gripping the body. The body is flexible and can be used as a tension exerciser between two body parts. When weights are inserted in the openings, the body becomes a dumbbell for lifting. According to the Rotella '364 patent, the weight is adjusted by using different mass inserts in the openings.

U.S. Pat. No. 4,482,151 to Zwilling teaches a barbell having housings for holding annular weights of increasing diameter on the ends of the barbell shaft. The housings have a plate connected to the shaft for mounting the annular weights against. An outer cylindrical cover fits over the mounted weights and the edge of the plate. The cover is held in place using threaded screws passing radially through locking nuts to contact the shaft and make a friction connection.

U.S. Pat. No. 702,356 to Calvert illustrates a barbell having housings at each end holding a variable volume of pellet weights, such as lead shot. An end cap is fitted over a threaded shaft at each end, pressed down over the pellet weights and secured using a wing nut tightened on the threaded shaft.

U.S. Pat. No. 5,380,261 to Mora for an exerciser having an adjustable resistance cord winding on a handle with the other end of the cord connected to a weight.

U.S. Pat. No. 3,982,755 to Sarich. The weight is a container; the mass of the weight may be changed by adding a liquid such as water to the container. A cord connects the handle and weight. The handle has a tapered middle section, so that the handle may be rotated by hand to wind the cord about the middle section, thereby raising and lowering the weight and strengthening the wrists.

U.S. Pat. No. 5,037,087 to Roth, in which the handle and cord are connected to a bottle weight by a threaded connection on the neck of the bottle. The Roth '087 exerciser is used in the same manner as the Sarich '755 device.

Several Patents Disclose Cord Retraction Devices having One End Adapted for a Person to Pull.

U.S. Pat. No. 5,176,599 to Beliakov discloses a resistance exerciser having a cord retraction mechanism fixed to a wall and the free end of the cord attached to a boxing glove. A person may exercise with the device by practicing boxing punches while wearing the glove, so that the cord and retraction mechanism pull against the forward motion of the punch. Alternatively, the cord can be connected to an ankle strap to provide resistance for kicks.

U.S. Pat. No. 3,752,475 to Ott discloses a wheel mounted on a shaft having handles extending from each side of the wheel. A resistance mechanism is included between the wheel and the shaft. The Ott '475 exerciser is designed for a person to grip the handles and extend their body forward from a kneeling to nearly prone position and return, while the mechanism in the wheel provides additional resistance for exercising against.

U.S. Pat. No. 5,499,961 to Mattox teaches a rolling exerciser having a frame supporting rollers on a shaft. A person can extend his body from a kneeling to a prone position and back while gripping handles located on the shaft on either side of the rollers. The frame includes a guide for the rollers, a stop to prevent the rollers from going too far and knee pads. The ends of the roller shaft are bent backwards and slidably connected to the frame behind the knee pads.

U.S. Pat. Nos. 6,146,318 to Kuo and 6,053,853 to Hinds each disclose different types of rolling exercisers having handles mounted to means for rolling across a flat surface. The Hinds '853 patent is particularly adapted for securing a person's feet to the handles. These exercisers are otherwise clearly different from the invention.

### DESCRIPTION OF DRAWINGS

FIG. 1

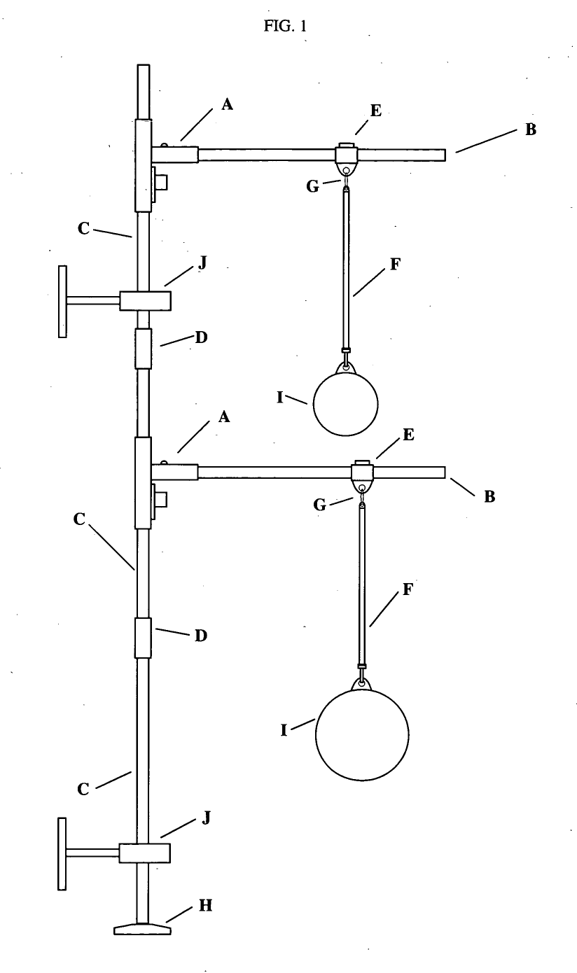

This figure is an elevation view showing the complete unit full unit as it would be when installed against a stationary wall. All component parts are labeled per the listing on the next page

FIG. 2

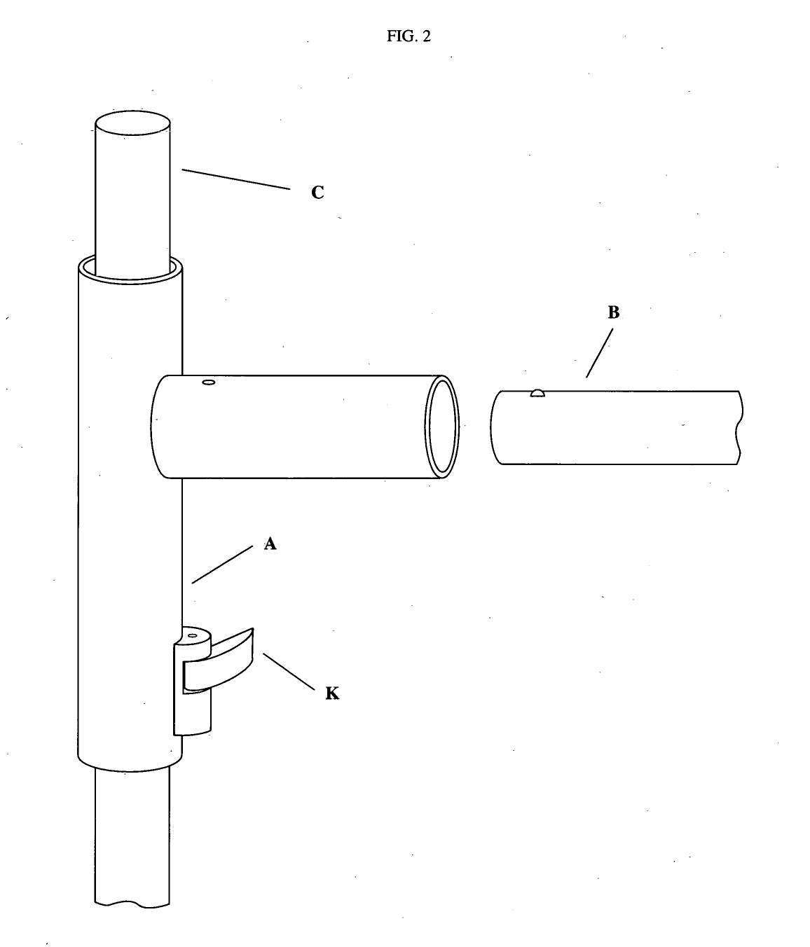

This figure is a detail view showing how the Adjustable Bracket (A) fits onto the Vertical Pole (C) and how the Horizontal Arm (B) fits into it. It also shows the Friction Lever (K) which is a component part of the Adjustable Bracket (A).

FIG. 3

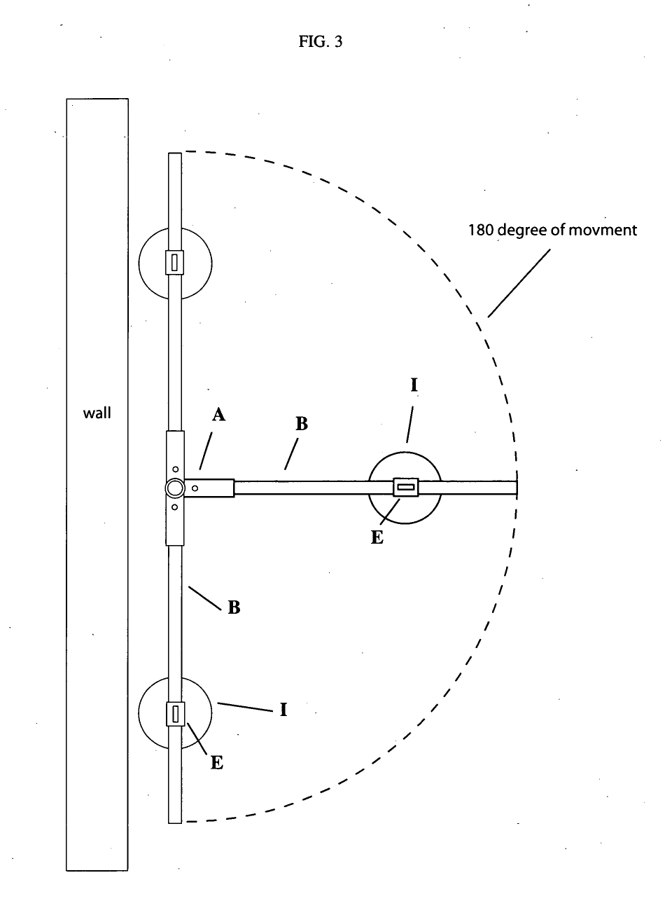

This figure is a plan view showing the full unit with the Horizontal Arm (B) in 3 different positions in a swivel range of 180 degrees.

FIG. 4

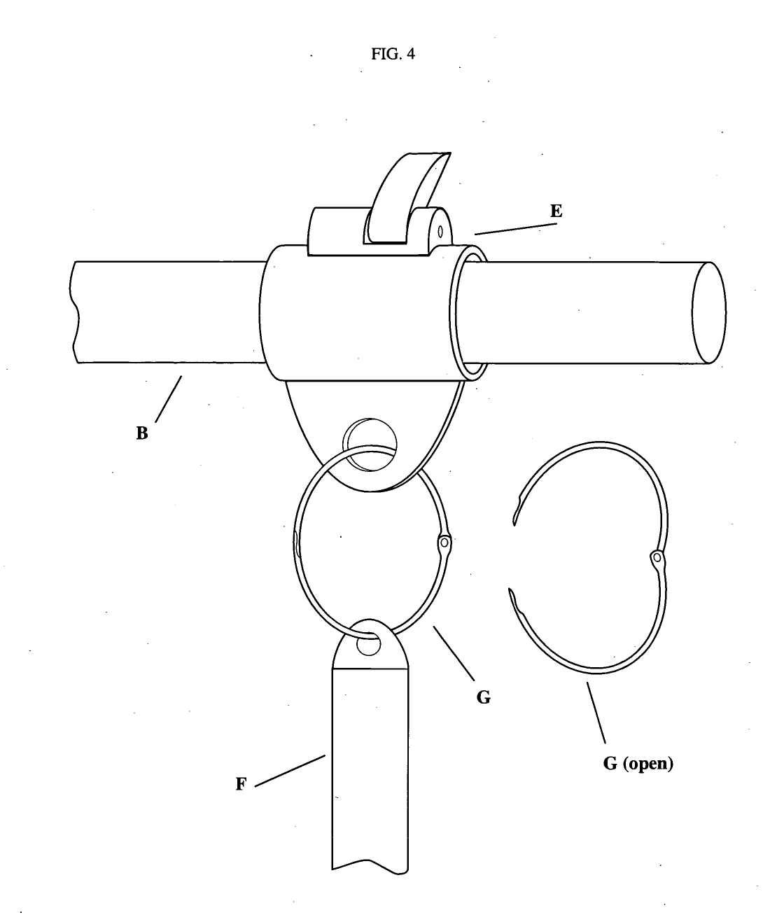

This figure is a detail view showing how the Adjustable Tether Connector (E) attaches to the Horizontal Ann (B). It also shows the Break-Away Safety Link (G) in both the closed and open states. This piece is designed to pull open when excessive wight is applied to it, releasing the Tether (F) from attachment to the Adjustable Tether Connector (E).

FIG. 5

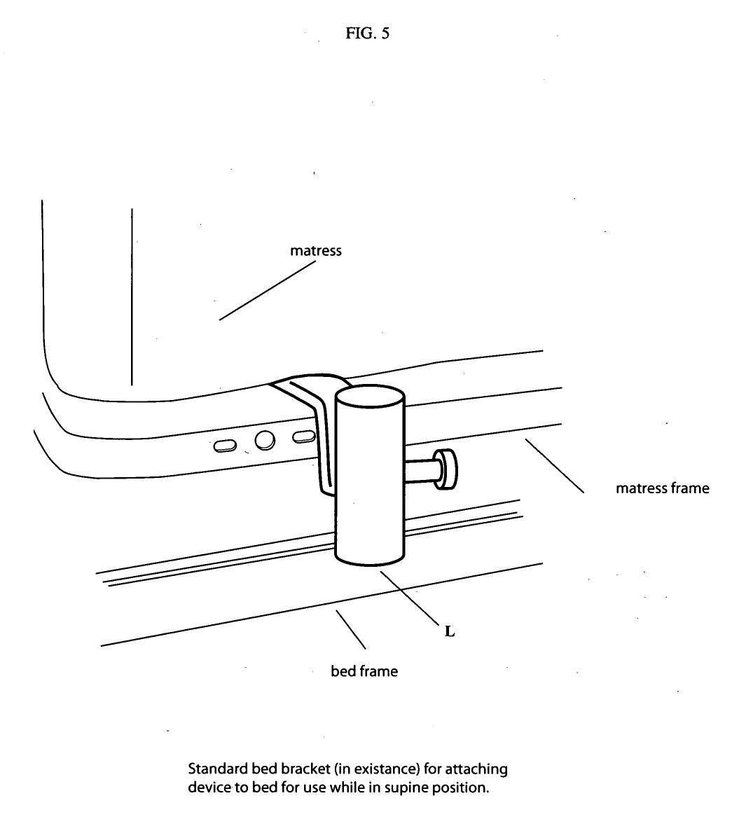

This figure is a detail view of a standard bed frame with the Bed Frame Bracket (L) attached, allowing the unit to be fixed securely to the bed.

FIG. 6

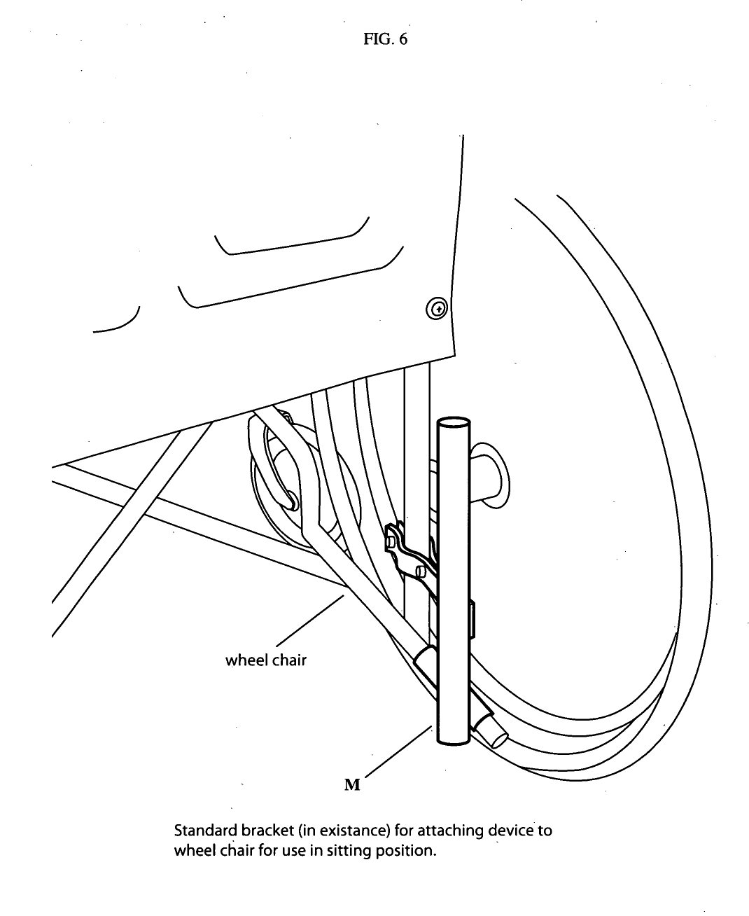

This figure is a detail view of a standard wheel chair with the Wheel Chair Bracket (M) attached, allowing the unit to be fixed securely to the wheel chair.

FIG. 7

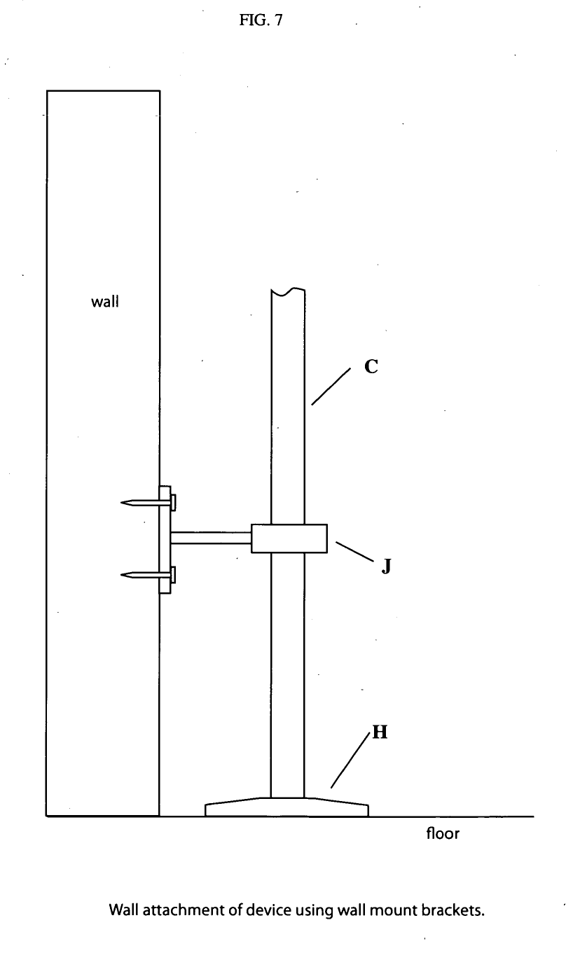

This figure is a detail view showing the Floor Base (H) portion of the unit installed against a fixed wall.

### LISTING OF COMPONENT PARTS

Below is a complete listing of individual component parts that make up a complete unit. These same letters are used for reference on all drawings contained in this application.
A. Adjustable Bracket
B. Horizontal arms
C. Vertical Pole
D. Vertical Pole Connector
E. Adjustable Tether Connector
F. Tether
G. Break-Away Safety Link
H. Floor Base
I. Ball
J. Wall Mount Bracket
K. Friction Lever
L. Bed Frame Bracket
M. Wheel Chair Bracket

1. The present invention relates generally to a method/system that enables almost any individual to hold, hit, throw and catch any appropriate object/devise in the field (ball, disc, ring) repetitively and successfully.

2. This device enables one individual to do multiple tasks at one time with or without looking at each task being done individually through the use of the multiple arms and connected tethers allowing multiple targets to be suspended in such a way that they return to their individual starting points.

3. The increased adjustability of both the height and position results in a unit that can be quickly adjusted to fit any individual in any position necessary to perform the exercise, including those confined to either a bed, chair or wheel chair.
